(19) United States
(12) Patent Application Publication
(10) Pub. No.: US 2021/0165125 A1
(43) Pub. Date: Jun. 3, 2021

(54) METHOD OF UPSCALING AND DOWNSCALING GEOLOGICAL AND PETROPHYSICAL MODELS TO ACHIEVE CONSISTENT DATA INTERPRETATION AT DIFFERENT SCALES

(71) Applicant: Baker Hughes, a GE company, LLC, Houston, TX (US)

(72) Inventors: Leonty A. TABAROVSKY, Cypress, TX (US); Mikhail I. EPOV, Novosibirsk (RU)

(73) Assignee: Baker Hughes, a GE company, LLC, Houston, TX (US)

(21) Appl. No.: 16/770,504

(22) PCT Filed: Dec. 8, 2017
(86) PCT No.: PCT/RU2017/000923

§ 371 Date: Jun. 5, 2020

(51) Int. Cl. G01V 99/00; G06F 30/20

(52) U.S. Cl. CPC G01V 99/005; G06F 2113/08; G06F 30/20

(57) ABSTRACT

A method for generating a petrophysical model of a reservoir includes: selecting a depositional environment; modeling a sedimentation process in the depositional environment to produce a pore-scale model of a rock matrix of the reservoir having a lithology and facies of sedimentary rock; validating the pore-scale model using a core sample and/or known geological information to provide a validated pore-scale model; modeling the reservoir with the validated pore-scale model saturated with one or more selected fluids; upscaling one or more physical properties of the validated pore-scale model saturated with the one or more selected fluids to dimensions at which at least one macro-scale property can be measured by a downhole tool to provide an upscaled model having one or more macro-scale properties; and validating the upscaled model using the at least one macro-scale property measured by the downhole tool to provide the petrophysical model of the reservoir.

### BACKGROUND

Exploration, development and exploitation of earth reservoirs of hydrocarbons are goals that typically require producing models of the reservoirs. A model of a reservoir enables planning and implementing further physical actions to be performed on the reservoir in order realize the exploration, development and exploitation. In that the pursuit of these goals can be very costly, more accurate reservoir models are sought to increase the efficient use of resources. Hence, it would be appreciated in the hydrocarbon production industry if methods were developed to produce more accurate models of hydrocarbon reservoirs.

### BRIEF SUMMARY

Disclosed is a method for generating a petrophysical model of a reservoir. The method includes: selecting a depositional environment for depositing sediments; modeling a sedimentation process in the depositional environment to produce a pore-scale model of a rock matrix of the reservoir having a lithology and facies of sedimentary rock to provide a pore-scale model of the rock matrix of the reservoir; validating the pore-scale model of the rock matrix using a core sample and/or known geological information to provide a validated pore-scale model of the rock matrix; modeling the reservoir with the validated pore-scale model of the rock matrix saturated with one or more selected fluids; upscaling one or more physical properties of the validated pore-scale model of the rock matrix saturated with the one or more selected fluids to dimensions at which at least one macro-scale property can be measured by a downhole tool to provide an upscaled model having one or more macro-scale properties; and validating the upscaled model using the at least one macro-scale property measured by the downhole tool to provide the petrophysical model of the reservoir.

### BRIEF DESCRIPTION OF THE DRAWINGS

The following descriptions should not be considered limiting in any way. With reference to the accompanying drawings, like elements are numbered alike:

FIG. 1 is a flow chart for a method for generating a petrophysical model of a reservoir;

FIG. 2 is a flow chart for a method for performing a physical action on the reservoir using a petrophysical model of the reservoir;

FIG. 3 depicts aspects of apparatus for drilling a borehole penetrating the reservoir for performing the physical action; and

FIG. 4 depicts aspects of apparatus for producing hydrocarbons from the reservoir for performing the physical action.

### DETAILED DESCRIPTION

A detailed description of one or more embodiments of the disclosed apparatus and method presented herein by way of exemplification and not limitation with reference to the figures.

Data acquired in the process of exploration, development, and exploitation of hydrocarbon reservoirs reflects the Earth physical and other properties at multiple scales: from pores to large geological structures. Correspondingly, models accounting for these properties are different at different scales. They must be properly linked in accordance with physical, chemical, and geological laws. The process of linking models at multiple scales is called either upscaling (from pore to geology) or downscaling (from geology to pore). Upscaling may also be referred to as homogenization.

As an overview, disclosed are embodiments of methods and apparatuses for generating an accurate petrophysical model of a reservoir containing hydrocarbons and performing a physical action using the petrophysical model. The methods develop consistent, across spatial scales, geological and petrophysical models to use in the inversion of data acquired on the Earth surface (e.g., seismic, gravity, etc.) and in the wellbore (various logs). Generating the petrophysical model involves downscaling from sediment layers to a pore-scale or micro-scale model of rock matrix of the reservoir. The method further involves modeling the rock matrix with a fluid saturating the rock matrix and then upscaling the saturated rock matrix model to larger dimensions in order to estimate reservoir properties at the macro-scale to provide the petrophysical model. The petrophysical model is then used to perform a physical action on the reservoir such as drilling a borehole in a specified location with a specified trajectory or fracturing the reservoir at certain depth intervals as non-limiting examples.

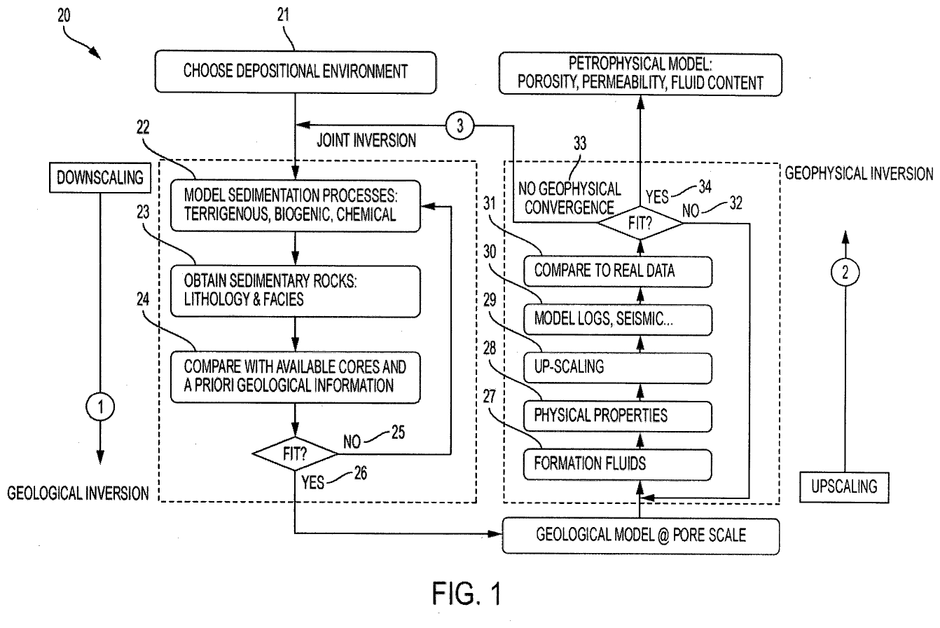

FIG. 1 is a flow chart for a method 20 for generating a petrophysical model of a reservoir. Block 21 calls for selecting a depositional environment for depositing sediments. The depositional environment relates to an environment in which each of the sediments are disposed to form sediment layers. Non-limiting embodiments of the environment include temperature, rainfall, biological material, and chemical material as function of time. The depositional environment can be selected based on a rock outcrop and/or known geological information for example.

Block 22 calls for modeling a sedimentation process in the depositional environment to produce a pore-scale model of a rock matrix. In one or more embodiments, the sedimentation process includes a terrigenous sedimentation process, a biogenic sedimentation process, and a chemical sedimentation process. In one or more embodiments, the terrigenous sedimentation process relates to deep-sea sediment transported to the oceans by rivers and wind from land sources. Terrigenous sediments that reach the continental shelf may be stored in submarine canyons on the continental slope. Turbidity currents can carry these sediments down into the deep sea. These currents create sedimentary deposits called turbidites, which are layers up to several meters thick composed of sediment particles that grade upward from coarser to finer sizes. The turbidites can build sedimentary deep-sea fans adjacent to the base of the continental slope. Turbidites can also be found below the major river deltas of the world where they build features called abyssal cones.

In one or more embodiments, the biogenic sedimentation process relates to the deposition of biogenic sediments, which are defined as containing at least 30% skeletal remains of marine organisms, and cover approximately 62% of the deep ocean floor. Clay minerals make up most of the non-biogenic constituents of these sediments. While a vast array of plants and animals contribute to the organic matter that accumulates in marine sediments, a relatively limited group of organisms may contribute significantly to the production of biogenic deep-sea sediments, which are either calcareous or siliceous oozes. Distributions and accumulation rates of biogenic oozes in oceanic sediments can depend on three major factors: rates of production of biogenic particles in the surface waters; dissolution rates of those particles in the water column and after they reach the bottom; and rates of dilution by terrigenous sediments. The abundances and distributions of the organisms that produce biogenic sediments may depend upon such environmental factors as nutrient supplies and temperature in the oceanic waters in which the organisms live. Dissolution rates are may be dependent upon the chemistry of the deep ocean waters through which the skeletal remains settle and of the bottom and interstitial waters in contact with the remains as they accumulate and are buried. The chemistry of deep-sea waters, can, in turn, be influenced by the rate of supply of both skeletal and organic remains of organisms from surface waters. It can also be heavily dependent upon the rates of deep ocean circulation and the length of time that the bottom water has been accumulating CO₂ and other byproducts of biotic activities.

In one or more embodiments, the chemical sedimentation process is understood in terms of chemical principles and laws. Chemical sedimentation may include the process of deposition of a solid material from a state of suspension or solution in a fluid (usually may be air or water). It may also include deposits from glacial ice and those materials collected under the impetus of gravity alone, as in talus deposits, or accumulations of rock debris at the base of cliffs. Chemical sedimentary rock is generally formed when minerals, dissolved in water, begin to precipitate out of solution and deposit at the base of the water body. This can occur in areas where sea water evaporates, depositing rock salt or gypsum for example. Due to the manner in which they are formed, these types of rocks may exhibit a crystalline texture. This texture can also occur in rocks that have undergone some form of recrystallization during the lithification process. This most often occurs in rocks produced by the accumulation of siliceous or calcareous tests (or shells) of microorganisms. During the burial process, water may react within the small pores and recrystallize into fine-grained texture. Because most chemical sedimentary rocks are formed in marine environments, fossils may be found within chemically precipitated rocks.

By estimating a length of time (t) that a specific set of environmental parameters exist for the depositional environment and a rate of deposition (R) of sediments based upon the estimated depositional processes in effect for that length of time, a thickness (Th) of a sediment layer can be calculated (e.g., Th=R*t). Hence, thicknesses of multiple layers and their corresponding structure and properties at the pore-scale level can be estimated.

Still referring to FIG. 1, block 23 calls for obtaining a lithology and facies of sedimentary rock resulting from the modelling of the sedimentation process to provide a pore-scale model of the rock matrix of the reservoir. In general, the lithology and facies are a function of location (including depth) in the reservoir. In one or more embodiments, the lithology relates to the microscopic nature of the mineral content such as grain size, texture and color of rocks. In one or more embodiments, facies relate to the overall characteristics of a rock unit that reflect its origin and differentiate the unit from others around it. Mineralogy and sedimentary source, fossil content, sedimentary structures and texture distinguish one facies from another. The lithology and facies provide properties of the rock matrix at pore-scale or micro-scale (i.e., properties based on dimensions of the pores in the rock matrix).

Block 24 calls for comparing a property of the pore-scale model of the rock matrix with the property of a core sample and/or known (i.e., a priori) geological information. The property can include one or more properties as determined from the lithology and facies of the pore-scale model.

Block 25 calls for modifying the sedimentation process and iterating the modelling, obtaining and comparing in response to the property of the pore-scale model of the rock matrix being outside a selected range about the property of a core sample and/or known geological information.

Block 26 calls for using the pore-scale model of the rock matrix for generating the petrophysical model of the reservoir in response to the property of the pore-scale model of the rock matrix being within a selected range about the property of a core sample and/or known geological information.

Block 27 calls for modeling the reservoir with the pore-scale model of the rock matrix saturated with one or more selected fluids. Non-limiting embodiments of the selected fluid include hydrocarbon oil, hydrocarbon gas, water, and drilling fluid. Specific types or compositions of these fluids (e.g., oil or gas type, water salinity and drill fluid composition) may be modeled. It can be appreciated that different fluids may saturate the rock matrix in different locations. For example, drilling fluid may saturate the rock matrix in a wall of a borehole penetrating the reservoir, while oil may saturate the rock matrix deeper in the reservoir away from the borehole.

Block 28 calls for identifying one or more physical properties of the pore-scale model of the rock formation saturated with the one or more selected fluids. Non-limiting embodiments of the physical properties include electrical resistance or conductivity of various materials making up the reservoir, rock matrix material and corresponding physical properties, pore size, connectivity between pores, and saturated fluid properties such as sound speed. These physical parameters can be identified based on knowledge of the physical structure of the pore-scale model and the physical properties of the one or more selected fluids saturating the pore-scale model.

Block 29 calls for upscaling the one or more physical properties of the pore-scale model of the rock matrix saturated with the one or more selected fluids to dimensions that can be sensed by a downhole tool to provide an upscaled model or synthetic model having one or more macro-scale properties.

Block 30 calls for inverting the one or more macro-scale properties of the upscaled model to provide one or more synthetic macro-scale properties that would be sensed by a downhole logging tool. That is, geophysical inversion of the macro-scale properties of the synthetic model result in estimating measured properties that would be measured by one of more downhole logging tools. In one or more embodiments, a physical field that would be applied by a downhole logging tool is modeled in order to estimate a response of that downhole logging tool due to the application of the physical field. Non-limiting embodiments of the one or more synthetic macro-scale properties include resistivity or conductivity, acoustic or seismic wave speed, porosity, permeability, density and elastic moduli.

Block 31 calls for comparing the one or more synthetic macro-scale properties to one or more corresponding actual macro-scale properties measured by one or more downhole logging tools. This block may also include measuring the one or more corresponding actual macro-scale properties using one or more downhole logging tools.

Block 32 calls for changing one or more of the physical properties of the pore-scale model saturated with the one or more selected fluids and iterating the modelling, identifying, upscaling, inverting, and comparing in response to the one or more synthetic macro-scale properties being outside of a selected range about the one or more corresponding actual macro-scale properties measured by one or more downhole logging tools.

Block 33 calls for changing at least one of the depositional environment and the sedimentation process in response to the iterating not converging to a solution where the one or more synthetic macro-scale properties are within a selected range about the one or more corresponding actual macro-scale properties measured by one or more downhole logging tools.

Block 34 calls for using the upscaled model as the petrophysical model in response to the one or more synthetic macro-scale properties being within a selected range about the one or more corresponding actual macro-scale properties measured by one or more downhole logging tools.

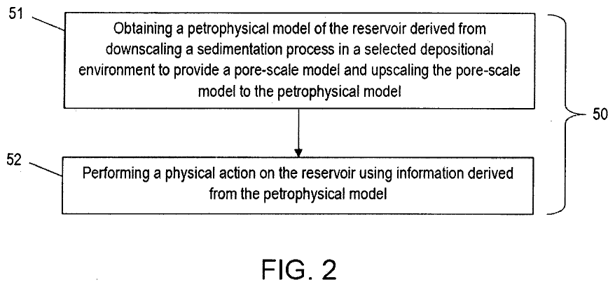

Once the petrophysical model is obtained, then a physical action can be planned and performed on the reservoir using that petrophysical model. FIG. 2 is a flow chart for a method 50 for performing a physical action on the reservoir using a petrophysical model of the reservoir. Block 51 calls for obtaining a petrophysical model of the reservoir derived from downscaling a sedimentation process in a selected depositional environment to provide a pore-scale model and upscaling the pore-scale model to the petrophysical model. Block 52 calls for performing the physical action on the reservoir using information derived from the petrophysical model. In one or more embodiments, the physical action involves drilling a borehole at a selected location and/or with a selected trajectory. In one or more embodiments, the selected location and/or the selected trajectory are selected based on information in the petrophysical model in order to efficiently or optimally extract hydrocarbons from the reservoir. In one or more embodiments, the physical action involves stimulating (e.g., hydraulic fracturing) the reservoir over a selected depth interval. In one or more embodiments, the selected depth interval is selected based on information in the petrophysical model in order to efficiently or optimally extract hydrocarbons from the reservoir.

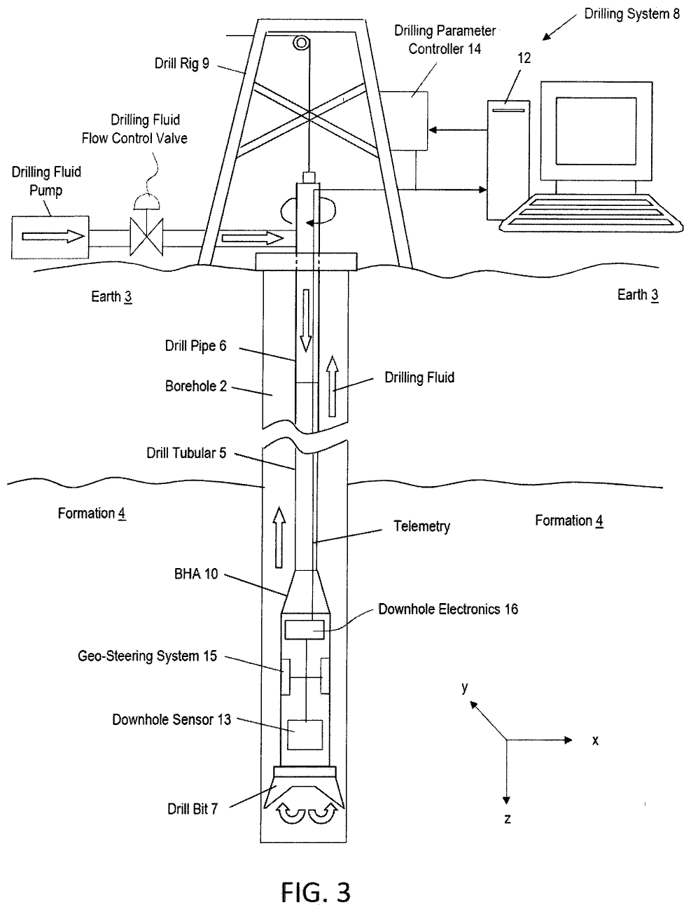

Apparatus for implementing the disclosure is now presented. FIG. 3 illustrates a cross-sectional view of a drilling system 8 configured to drill a borehole 2 in the earth 3, which includes an earth formation 4. The drilling system 8 includes a drill tubular 5, which may be formed from a string of coupled drill pipes 6, and a drill bit 7 disposed at the distal end of the drill tubular 5. The drill bit 7 is configured to be rotated by the drill tubular 5 to drill the borehole 2. A bottomhole assembly (BHA) 10 may include the drill bit 7 as illustrated in FIG. 1 or it may be separate from the BHA 10. A drill rig 9 is configured to conduct drilling operations such as rotating the drill tubular 5 and thus the drill bit 7 in order to drill the borehole 2. In addition, the drill rig 9 is configured to pump drilling fluid (also referred to as drilling mud) through the drill tubular 5 in order to lubricate the drill bit 7 and flush cuttings from the borehole 2. The drill rig 9 may include a drilling fluid pump and drilling fluid flow control valve to control the flowrate of the drilling fluid. A mud motor (not shown) configured to provide further rotational energy to the drill bit 7 may also be included in the BHA 10. A geo-steering system 15 responsive to a control signal from a drilling parameter controller 14 via telemetry is configured to steer the drill bit 7 in a selected trajectory (may be inclusive azimuth and inclination as a function of depth). A computer processing system 12 may provide the selected trajectory to the drilling parameter controller 14 after processing information to generate the petrophysical model.

The BHA 10 may also include one or more downhole sensors 13. The downhole sensor 13 is configured to sense a formation or borehole property while drilling is being conducted or during temporary halt in drilling. Non-limiting embodiments of properties being sensed include, temperature, pressure, gamma-rays, neutrons, formation density, formation porosity, formation hardness, resistivity, dielectric constant, chemical element content, elastic moduli, and acoustic resistivity. Sensed data may be transmitted to the surface in real time via telemetry to the computer processing system 12, which may process the sensed data for use in validating the upscaled model to generate the petrophysical model. Downhole electronics 16 may be included in the BHA 10 to process measurements obtained from the one or more downhole sensors 13 and provide an interface for the telemetry to transmit data to the processing system 12 and receive command signals from the drilling parameter controller 14 for use by the geo-steering system 15.

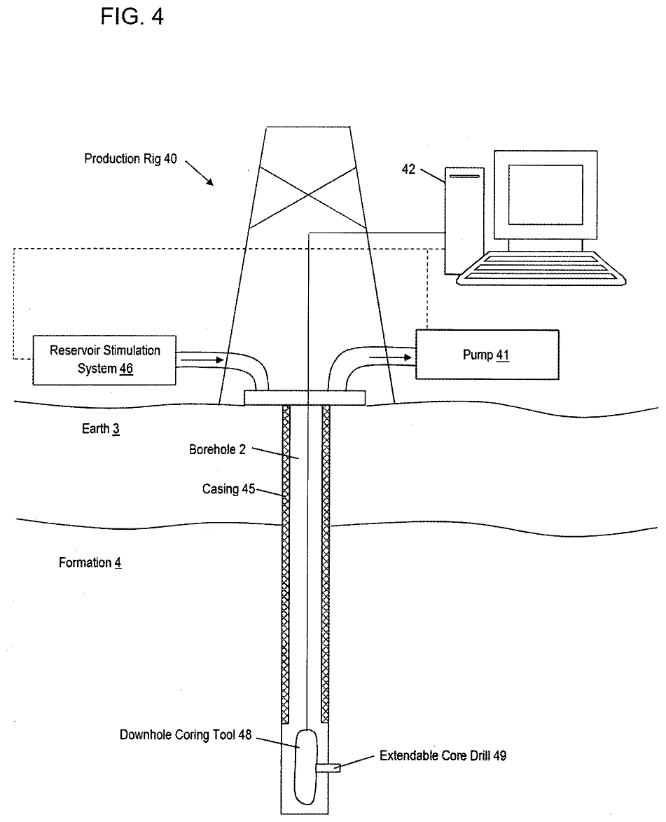

FIG. 4 depicts aspects of production equipment for producing hydrocarbons from an earth formation. A production rig 40 is configured to perform actions related to the production of hydrocarbons from the borehole 2 (may also be referred to as a well or wellbore) penetrating the earth 3 having the earth formation 4. The formation 4 may contain a reservoir of hydrocarbons that are produced by the production rig 40. The production rig 40 may include a pump 41 configured to pump hydrocarbons entering the borehole 2 to the surface. The pump 41 may include a valve (not shown) for controlling the flow rate of hydrocarbons being pumped in accordance with information derived from the petrophysical model. The borehole 2 may be lined by a casing 45 to prevent the borehole 2 from collapsing. The production rig 40 may include a reservoir stimulation system 46 configured to stimulate the earth formation 4 using information derived from the petrophysical model to increase the flow of hydrocarbons. In one or more embodiments, the reservoir stimulation system 46 is configured to hydraulically fracture rock in the formation 4.

The production rig 40 may also be configured to extract a core sample of the formation 4 using a downhole coring tool 48. The downhole coring tool 48 may be conveyed through the borehole 2 by an armored wireline that also provides communications to the surface. The core sample may be extracted using an extendable core drill 49. Once the core sample is extracted, it is stored and conveyed to the surface for analysis. In general, a plurality of core samples is extracted in order to adequately represent the properties of rock present in the formation in order to validate the pore-scale model. For example, a higher number of samples would be required if the properties change significantly with depth as opposed to not changing significantly with depth. In an alternative embodiment, the downhole tool 48 may be configured to perforate the casing 45 in a selected depth interval based on information derived from the petrophysical model.

FIG. 4 also illustrates a computer processing system 42. The computer processing system 42 is configured to implement the methods disclosed herein. Further, the computer processing system 42 may be configured to act as a controller for controlling operations of the production rig 40. Non-limiting examples of control actions include turning equipment on or off, setting setpoints, controlling pumping and/or flow rates, and executing processes for formation stimulation. In general one or more of the control actions may be determined using a formation parameter obtained from the verified model. In one or more embodiments, the computer processing system 42 may update or receive an update of the petrophysical model in real time and, thus, provide control actions in real time.

Set forth below are some embodiments of the foregoing disclosure: Embodiment 1. A method for generating a petrophysical model of a reservoir, the method comprising: selecting a depositional environment for depositing sediments; modeling a sedimentation process in the depositional environment to produce a pore-scale model of a rock matrix of the reservoir having a lithology and facies of sedimentary rock to provide a pore-scale model of the rock matrix of the reservoir; validating the pore-scale model of the rock matrix using a core sample and/or known geological information to provide a validated pore-scale model of the rock matrix; modeling the reservoir with the validated pore-scale model of the rock matrix saturated with one or more selected fluids; upscaling one or more physical properties of the validated pore-scale model of the rock matrix saturated with the one or more selected fluids to dimensions at which at least one macro-scale property can be measured by a downhole tool to provide an upscaled model having one or more macro-scale properties; and validating the upscaled model using the at least one macro-scale property measured by the downhole tool to provide the petrophysical model of the reservoir.

Embodiment 2. The method according to any prior embodiment, further comprising performing a physical action on the reservoir using corresponding apparatus, the physical action being based on information derived from the petrophysical.

Embodiment 3. The method according to any prior embodiment, wherein the physical action comprises drilling a borehole penetrating the reservoir at a selected location and/or with a selected trajectory and the apparatus comprises a drilling system.

Embodiment 4. The method according to any prior embodiment, wherein the physical action comprises stimulating the reservoir and the apparatus comprises a reservoir stimulation system.

Embodiment 5. The method according to any prior embodiment, wherein the sedimentation process comprises a terrigenous sedimentation process, a biogenic sedimentation process, and/or a chemical sedimentation process.

Embodiment 6. The method according to any prior embodiment, wherein validating the pore-scale model comprises comparing a property of the pore-scale model of the rock matrix with the property of a core sample and/or known geological information.

Embodiment 7. The method according to any prior embodiment, further comprising modifying the sedimentation process and iterating the modelling and validating in response to the property of the pore-scale model of the rock matrix being outside a selected range about the property of a core sample and/or known geological information.

Embodiment 8. The method according to any prior embodiment, further comprising using the pore-scale model of the rock matrix as the validated pore-scale model of the rock matrix in response to the property of the pore-scale model of the rock matrix being within a selected range about the property of a core sample and/or known geological information.

Embodiment 9. The method according to any prior embodiment, wherein the one or more selected fluids comprise oil, gas, and/or water.

Embodiment 10. The method according to any prior embodiment, wherein the one or more physical properties of the validated pore-scale model of the rock matrix saturated with the one or more selected fluids comprise dimensions of pores, pore material elasticity, pore material density, pore connectivity, electrical resistivity, acoustic resistivity, temperature, and/or pressure.

Embodiment 11. The method according to any prior embodiment, further comprising performing a logging measurement of the at least one macro-scale property using the downhole tool.

Embodiment 12. The method according to any prior embodiment, wherein validating the upscaled model comprises comparing the at least one macro-scale property measured by the downhole tool to a modeled downhole measurement of that at least one macro-scale property using the upscaled model.

Embodiment 13. The method according to any prior embodiment, further comprising using the upscaled model as the petrophysical model of the reservoir in response to the at least one macro-scale property measured by the downhole tool being within a selected range of the modeled downhole measurement of that at least one macro-scale property.

Embodiment 14. The method according to any prior embodiment, further comprising iterating the modeling the reservoir, the upscaling, and the validating the upscaled model in response to the at least one macro-scale property measured by the downhole tool not being within a selected range of the modeled downhole measurement of that at least one macro-scale property.

Embodiment 15. The method according to any prior embodiment, further comprising changing at least one of the depositional environment and the sedimentation process and iterating the selecting, the modeling a sedimentation process, the validating the pore-scale model, the modeling the reservoir, the upscaling, and the validating the upscaled model in response to the at least one macro-scale property measured by the downhole tool not converging to within a selected range of the modeled downhole measurement of that at least one macro-scale property.

Embodiment 16. The method according to any prior embodiment, wherein the petrophysical model comprises a porosity value, a permeability value, and a fluid content value.

Embodiment 17. The method according to any prior embodiment, further comprising obtaining the core sample using a downhole coring tool.

In support of the teachings herein, various analysis components may be used, including a digital and/or an analog system. For example, the computer processing system 12, the one or more downhole sensors 13, the drilling parameter controller 14, the geo-steering system 15, the downhole electronics 16, the computer processing system 42, and/or the downhole tool 48 may include digital and/or analog systems. The system may have components such as a processor, storage media, memory, input, output, communications link (wired, wireless, optical or other), user interfaces (e.g., a display or printer), software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured. The terms “first” and “second” are used to differentiate elements and do not denote a particular order.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

The disclosure illustratively disclosed herein may be practiced in the absence of any element which is not specifically disclosed herein.

While one or more embodiments have been shown and described, modifications and substitutions may be made thereto without departing from the spirit and scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for generating a petrophysical model of a reservoir, the method comprising:
selecting a depositional environment for depositing sediments;
modeling a sedimentation process in the depositional environment to produce a pore-scale model of a rock matrix of the reservoir having a lithology and facies of sedimentary rock to provide a pore-scale model of the rock matrix of the reservoir;
validating the pore-scale model of the rock matrix using a core sample and/or known geological information to provide a validated pore-scale model of the rock matrix;
modeling the reservoir with the validated pore-scale model of the rock matrix saturated with one or more selected fluids;
upscaling one or more physical properties of the validated pore-scale model of the rock matrix saturated with the one or more selected fluids to dimensions at which at least one macro-scale property can be measured by a downhole tool to provide an upscaled model having one or more macro-scale properties; and
validating the upscaled model using the at least one macro-scale property measured by the downhole tool to provide the petrophysical model of the reservoir.

2. The method according to claim 1, further comprising performing a physical action on the reservoir using corresponding apparatus, the physical action being based on information derived from the petrophysical.

3. The method according to claim 2, wherein the physical action comprises drilling a borehole penetrating the reservoir at a selected location and/or with a selected trajectory and the apparatus comprises a drilling system-.

4. The method according to claim 2, wherein the physical action comprises stimulating the reservoir and the apparatus comprises a reservoir stimulation system.

5. The method according to claim 1, wherein the sedimentation process comprises a terrigenous sedimentation process, a biogenic sedimentation process, and/or a chemical sedimentation process.

6. The method according to claim 1, wherein validating the pore-scale model comprises comparing a property of the pore-scale model of the rock matrix with the property of a core sample and/or known geological information.

7. The method according to claim 6, further comprising modifying the sedimentation process and iterating the modelling and validating in response to the property of the pore-scale model of the rock matrix being outside a selected range about the property of a core sample and/or known geological information.

8. The method according to claim 6, further comprising using the pore-scale model of the rock matrix as the validated pore-scale model of the rock matrix in response to the property of the pore-scale model of the rock matrix being within a selected range about the property of a core sample and/or known geological information.

9. The method according to claim 1, wherein the one or more selected fluids comprise oil, gas, and/or water.

10. The method according to claim 1, wherein the one or more physical properties of the validated pore-scale model of the rock matrix saturated with the one or more selected fluids comprise dimensions of pores, pore material elasticity, pore material density, pore connectivity, electrical resistivity, acoustic resistivity, temperature, and/or pressure.

11. The method according to claim 1, further comprising performing a logging measurement of the at least one macro-scale property using the downhole tool.

12. The method according to claim 1, wherein validating the upscaled model comprises comparing the at least one macro-scale property measured by the downhole tool to a modeled downhole measurement of that at least one macro-scale property using the upscaled model.

13. The method according to claim 12, further comprising using the upscaled model as the petrophysical model of the reservoir in response to the at least one macro-scale property measured by the downhole tool being within a selected range of the modeled downhole measurement of that at least one macro-scale property.

14. The method according to claim 12, further comprising iterating the modeling the reservoir, the upscaling, and the validating the upscaled model in response to the at least one macro-scale property measured by the downhole tool not being within a selected range of the modeled downhole measurement of that at least one macro-scale property.

15. The method according to claim 14, further comprising changing at least one of the depositional environment and the sedimentation process and iterating the selecting, the modeling a sedimentation process, the validating the pore-scale model, the modeling the reservoir, the upscaling, and the validating the upscaled model in response to the at least one macro-scale property measured by the downhole tool not converging to within a selected range of the modeled downhole measurement of that at least one macro-scale property.

16. The method according to claim 1, wherein the petrophysical model comprises a porosity value, a permeability value, and a fluid content value.

17. The method according to claim 1, further comprising obtaining the core sample using a downhole coring tool.
